(19) United States
(12) Patent Application Publication
(10) Pub. No.: US 2009/0070844 A1
(43) Pub. Date: Mar. 12, 2009

(54) VIDEO OVER IP DISTRIBUTION SYSTEM AND METHOD

(76) Inventors: John C. BEER, San Diego, CA (US); Ronald D. Fellman, San Diego, CA (US)

Correspondence Address: DALINA LAW GROUP, P.C., 7910 IVANHOE AVE. #325, LA JOLLA, CA, 92037, US

(21) Appl. No.: 11/852,971

(22) Filed: Sep. 10, 2007

(51) Int. Cl. H04N 7/173

(52) U.S. Cl. 725/119

(57) ABSTRACT

Enables video over IP distribution system and method that multicasts or broadcasts IP messages over a local layer 2 network (generally for example in a known local network, e.g., a network within an Internet service provider or video provider) to eliminate intermediate replication servers. The system thus utilizes a flat architecture that distributes the same number of video streams as pyramid architectures, but utilizes less hardware, e.g., less replication servers and less network switches. Systems may be configured to transmit multiple versions of the same broadcast, for example at different sizes, resolutions or aspect ratios or at different bit rates or any combination thereof. Groupings of the system allow for customized broadcast of the same video. With respect to quality of service, various clock synchronization, forward error correction (FEC), automatic repeat request (ARQ) methods and systems may be utilized to provide higher quality of service for any embodiment of the invention.

### BACKGROUND OF THE INVENTION

1. Field of the Invention

Embodiments of the invention described herein pertain to the field of computer systems. More particularly, but not by way of limitation, one or more embodiments of the invention enable a video over IP distribution system and method.

2. Description of the Related Art

Current systems for distributing video over the Internet utilize unicast streams to form a hierarchical pyramid of replication servers that generally distribute video via TCP/IP transport protocol (Transmission Control Protocol, RFC 675 and RFC 793, over Internet Protocol). Video distribution over the Internet relies on this hierarchical structure of multiple TCP/IP unicast streams transmitted using Layer 4 (transport layer in the OSI Reference Model) communication protocols to provide reliable transport, since the Internet does not generally implement IGMP or any other mechanism to provide multicast functionality, and the TCP protocol only operates on a point-to-point connection basis and does not support multicasting. Because of this lack of support for multicasting and the need for a reliable transport mechanism between Internet nodes, current Internet video distribution systems must rely upon intermediate replication servers to form the upper echelon of the pyramid. The minimally sized pyramid is thus based on the logarithm of the total number of streams that are to be distributed.

FIG. 1 shows an example of the related art. In this figure, the replication servers are all communicating via unicast streams. This is a great waste of bandwidth on each network that is utilized in interconnecting the various computers (each replication server is shown utilizing two separate networks, one for incoming and one for outgoing streams), since a large number of links transport redundant traffic. When using this architecture, there is no way to eliminate the intermediate replication servers lying between video source (leftmost server) and the Internet available servers (rightmost servers), since each replication server must communicate using a unicast one-to-one communications channel. In other words, the 4 servers in the middle of the architecture are required in this configuration, since the leftmost server cannot output enough copied streams to feed all of the servers on the rightmost side of the figure.

A method for eliminating the intermediate servers would lower hardware and communications costs and eliminate many of the network appliances utilized in coupling the intermediate computers to the leftmost and rightmost servers. Such a method would also eliminate much unnecessary loading of intermediate IP network links. For at least the limitations described above there is a need for a video over IP distribution system and method.

### BRIEF SUMMARY OF THE INVENTION

One or more embodiments of the invention enable a video over IP distribution system and method. The system utilizes IP multicast messages over a local Layer 2 or Layer 3 network (generally for example in a known local network, e.g., a network within an Internet service provider or video provider) to eliminate intermediate servers. The system thus utilizes a flat architecture that takes advantage of the multicast ability and reliability of a simple local network within an Internet node (for example an Ethernet network within an Internet service provider's (ISP) facility) and the high interconnectivity throughput of a typical Internet node to distribute the same number of video streams as pyramid architectures, but utilizes less hardware, e.g., less replication servers and less network switches.

A hierarchical pyramid-based architecture that distributes low bandwidth video streams may, for example, use replication servers that may each broadcast five hundred streams of 500 Kbps (320×240) video resolution for a total bandwidth of 250 Mbps. Such a system uses two levels of servers (501 servers) to distribute 250,000 streams of low resolution video. Embodiments of the invention may utilize 500 servers to accomplish the distribution of 250,000 streams since no intermediate server is required. Hence for low resolution video streams of this size and number, a savings of one replication server occurs.

However, when utilizing High Definition video streams, the typical bandwidth is 5 Mbps per stream. In this scenario, each replication server may transmit only 50 streams (instead of 500 in the low resolution example). Since distributing 250,000 streams now requires 5000 end replication servers, using a pyramid architecture requires four levels of replication servers (1, 2, 100, 5000 per pyramid level). This is the case since each replication server may only communicate the video to 50 other servers. The total number of replication servers required for high definition transmission is thus 5103. In contrast, embodiments of the invention only utilize 5000 servers for the same number of output streams (a savings of 103 servers). This is the case in various embodiments of the invention, since multicast is utilized on an internal network to eliminate the intermediate replication servers altogether. Because none or insignificant packet loss occurs within such an internal network of an Internet or ISP node, TCP and other forms of error correction are not required within this internal network. This invention takes advantage of this fact through the use of multicasting to replicate an incoming feed to many outgoing replication servers. Each replication server then converts the internally multicast video streams into multiple unicast streams, each generally using either TCP/IP protocol or UDP/IP with some form of error correction, to make the video transport reliable after leaving the Internet node.

In addition, embodiments of the invention may be configured to transmit multiple versions of the same broadcast, for example at different sizes, resolutions or aspect ratios or at different bit rates or any combination thereof. For compressed digital video, the incoming video may be altered by changing the compression type, by rate shaping the compressed digital video, by changing the video resolution or any combination thereof. Transmitting the same broadcast at multiple bit rates allows for multiple types of devices over networks of varying bandwidth to receive the same video (albeit at different frame rates and/or resolutions, etc.).

Furthermore, embodiments of the invention may be grouped to allow for the distribution of video in different geographic, or disparate corporate or alternate networks (mobile network versus Internet for example). In these cases, different watermarks or different processing may be utilized for error correction per network based on the type of network to control the quality of service provided by the system. With respect to quality of service, various clock synchronization, forward error correction (FEC), automatic repeat request (ARQ) methods and systems may be utilized to provide higher quality of service for any embodiment of the invention.

### BRIEF DESCRIPTION OF THE DRAWINGS

The above and other aspects, features and advantages of the invention will be more apparent from the following more particular description thereof, presented in conjunction with the following drawings wherein:

FIG. 1 is a related art brute force unicast implementation of a video over IP distribution system in a pyramid configuration.

FIG. 2 is an embodiment of the invention utilizing unicast without intermediate replication servers in a flat configuration.

FIG. 3 shows a larger sized embodiment of FIGS. 1 and 2 in a side by side view.

FIG. 4 shows an embodiment of the invention configured to distribute the same analog or digital video signal at different bit rates.

FIG. 5 shows an embodiment of the invention configured to distribute the same compressed digital video signal at different bit rates by recompressing the signal using a different algorithm, by changing the resolution of the video, by rate shaping the video or any combination of methods to change the bit rate.

FIG. 6 shows an embodiment of the invention configured for replication groups serving a geographic area, disparate companies or disparate networks that serve mobile phones or Internet based computers for example.

FIG. 7 shows a flow chart enabling an embodiment of the method.

### DETAILED DESCRIPTION

A video over IP distribution system and method will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

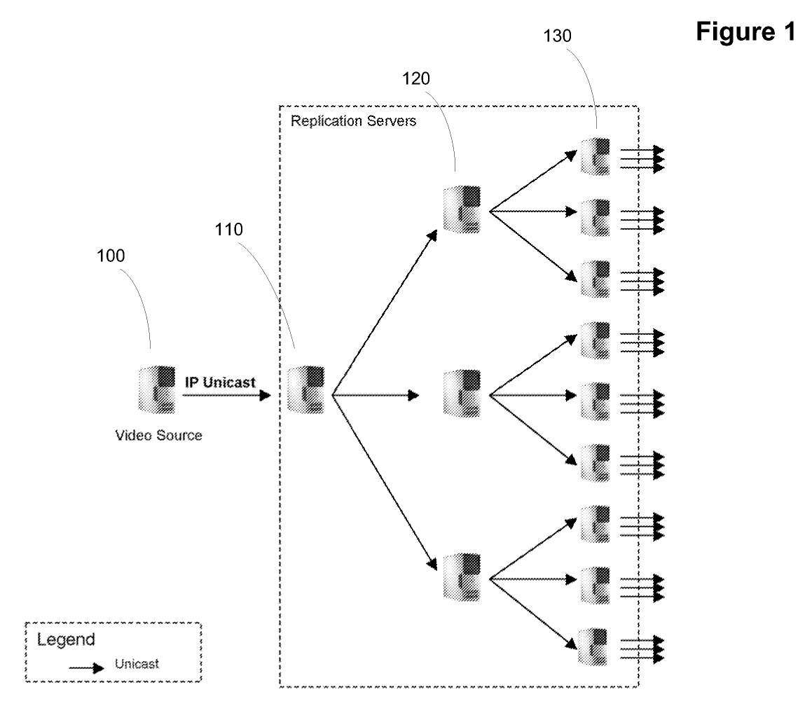

FIG. 1 is a related art brute force unicast implementation of a video over IP distribution system in a pyramid configuration. For low resolution video, the replication servers require few intermediate level replication servers. For high definition video, the number of intermediate replication servers 110 and 120 increases significantly as per the discussion in the brief summary section. Specifically, video source 100 transmits an IP unicast video using connection based communications to replication server level 110 which in turn transmits the same video to replication servers at level 120 which in turn transmit the same video to replication servers at level 130 for subsequent output over unicast connections to personal computers on the Internet for example.

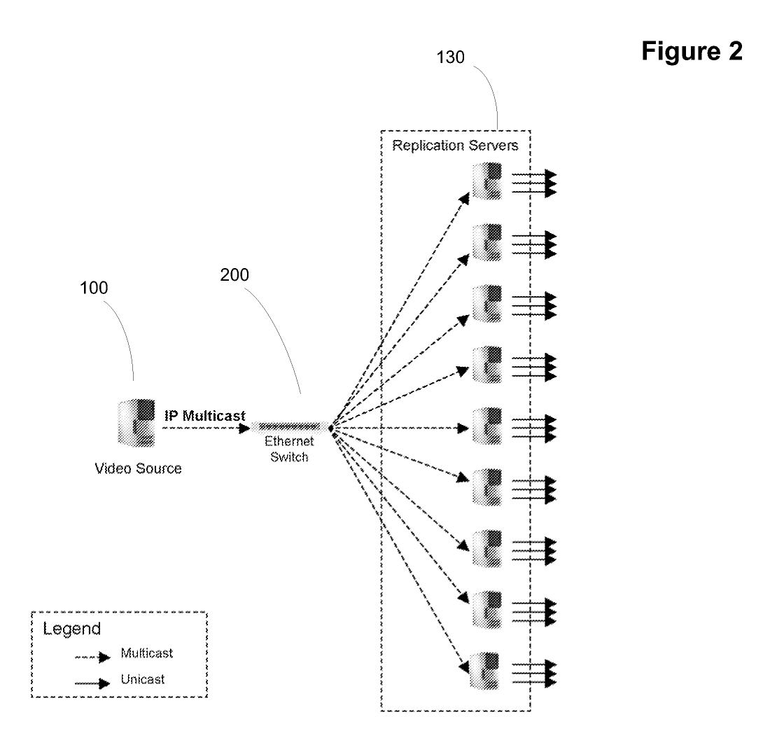

FIG. 2 is an embodiment of the invention utilizing unicast without intermediate replication servers in a flat configuration. Embodiments utilize Ethernet multicast messages over a local layer 2 network to eliminate intermediate servers. In the embodiment shown, video source 100 transmits the IP/Ethernet multicast video packets to Ethernet switch 200 which is configured to transmit the IP/Ethernet multicast video packets to multiple replication servers at level 130. Ethernet switch 200 may be implemented as a router or any other type of network device for example that is capable of coupling with multiple replication servers and communicating with the replication servers. The system thus utilizes a flat architecture of replication servers at level 130 that distributes the same number of video streams as pyramid architectures but utilizes less hardware, e.g., less replication servers and less network switches.

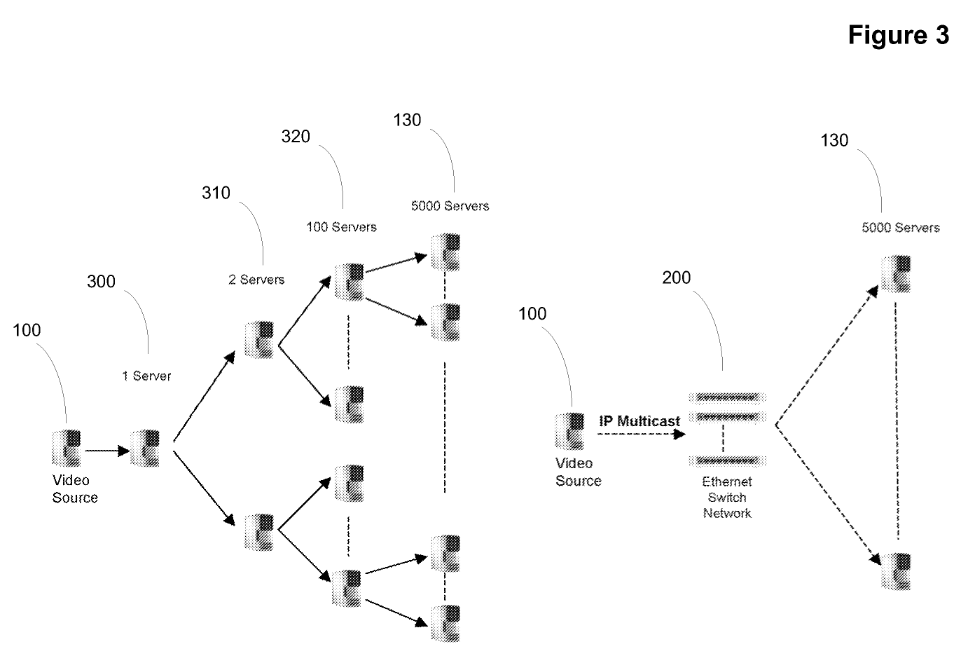

FIG. 3 shows a larger sized embodiment of FIGS. 1 and 2 in a side by side view. Specifically, the system is configured to distribute 250,000 High Definition video streams from video source 100. For High Definition video streams, the typical bandwidth is 5 Mbps per stream. In this scenario, each replication server may transmit 50 streams. Since distributing 250,000 streams using known solutions requires 5000 end replication servers, using a pyramid architecture requires four levels of replication servers (1, 2, 100, 5000 per pyramid level), i.e., level 300 (one server), level 310 (2 servers), level 320 (100 servers) and level 130 (5000 servers). This is the case since each replication server may only communicate the video to 50 other servers using unicast communications links. The total number of replication servers required for high definition transmission is thus 5103. In contrast, sending video from video source 100 via Ethernet switch 200 via replications servers at level 130 only utilizes 5000 servers for the same number of output streams (for a total savings of 103 servers). This is the case when utilizing various embodiments of the invention since IP multicast is utilized on an internal network to eliminate the intermediate replication servers altogether.

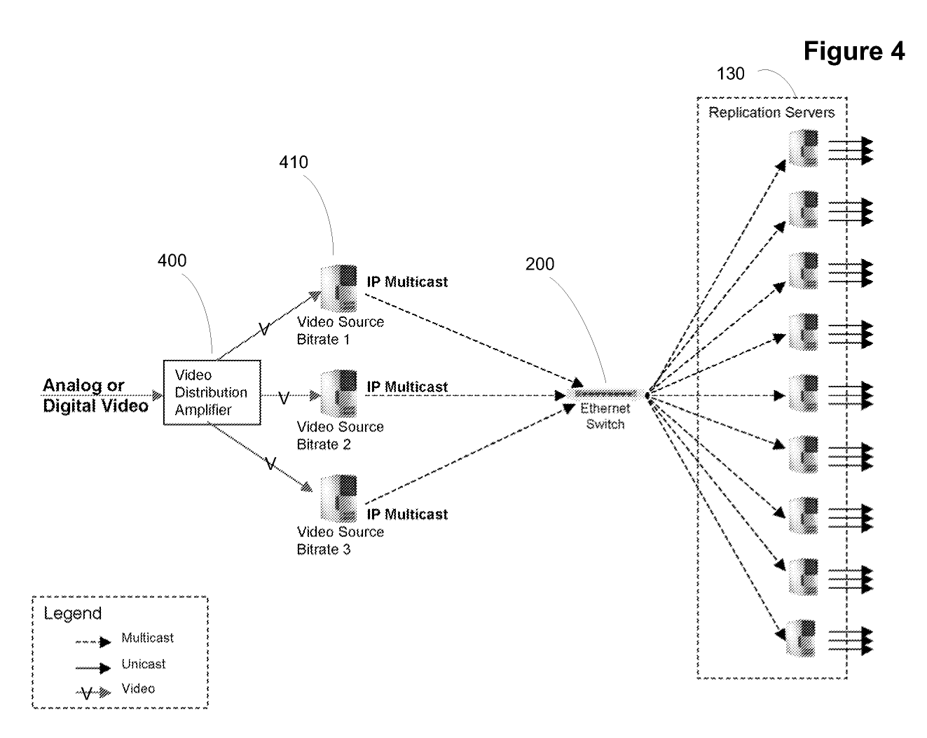

FIG. 4 shows an embodiment of the invention configured to distribute the same analog or digital video signal at different bit rates. This figure shows incoming analog or digital video entering video distribution amplifier 400 which is coupled with IP multicast video source level 410 computers which in turn are coupled with Ethernet switch 200. As in other embodiments of the invention, Ethernet switch 200 is configured to output video packets (however in this embodiment at various bit rates), to replication servers at level 130. Hence, embodiments of the invention are configured to transmit multiple versions of the same broadcast, for example at different sizes, resolutions or aspect ratios or at different bit rates or any combination thereof. For example, analog or digital video may be converted to different aspect ratios and made available to the replication servers.

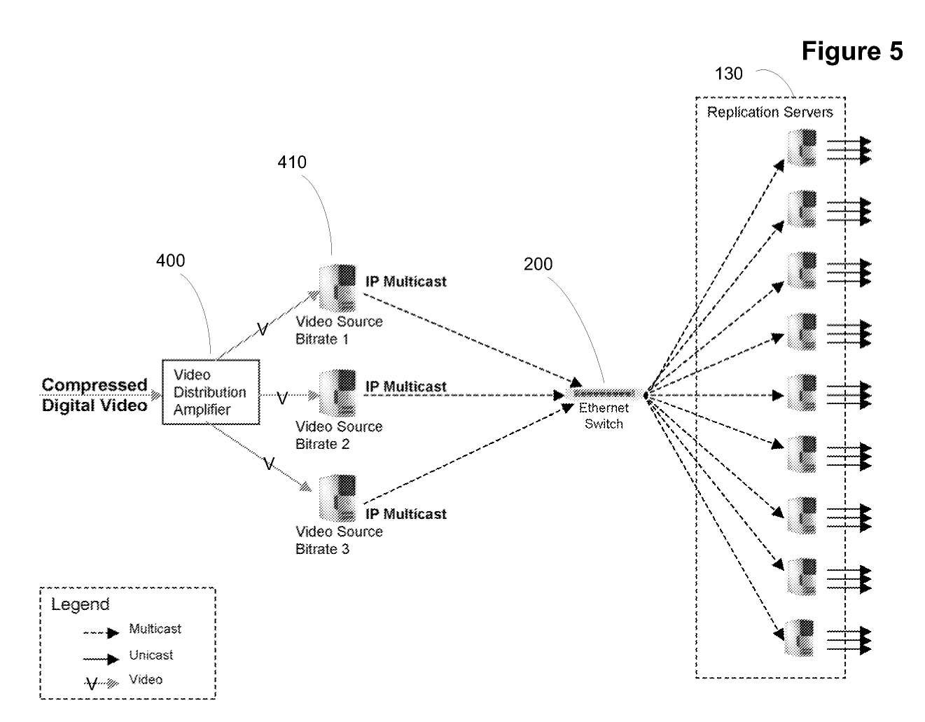

FIG. 5 shows an embodiment of the invention configured to distribute the same compressed digital video signal at different bit rates by recompressing the signal using a different algorithm, by changing the resolution of the video, by rate shaping the video or any combination of methods to change the bit rate. This figure shows incoming compressed digital video entering video distribution amplifier 400 (albeit in this case a digital distribution amp) which is coupled with IP/Ethernet multicast video source level 410 computers which in turn are coupled with Ethernet switch 200. As in other embodiments of the invention, Ethernet switch 200 is configured to output video packets (however in this embodiment at various bit rates), to replication servers at level 130. As in other embodiments of the invention, Ethernet switch 200 is configured to output video packets (however in this embodiment at various bit rates), to replication servers at level 130. For compressed digital video, the incoming video may be altered by changing the compression type, by rate shaping the compressed digital video, by changing the video resolution or any combination thereof. Transmitting the same broadcast at multiple bit rates allows for multiple types of devices over networks of varying bandwidth to receive the same video (albeit at different frame rates and/or resolutions, etc.). For example, an embodiment of the invention thus configured may output video to cell phones and computers each with various bandwidth limits and screen resolutions.

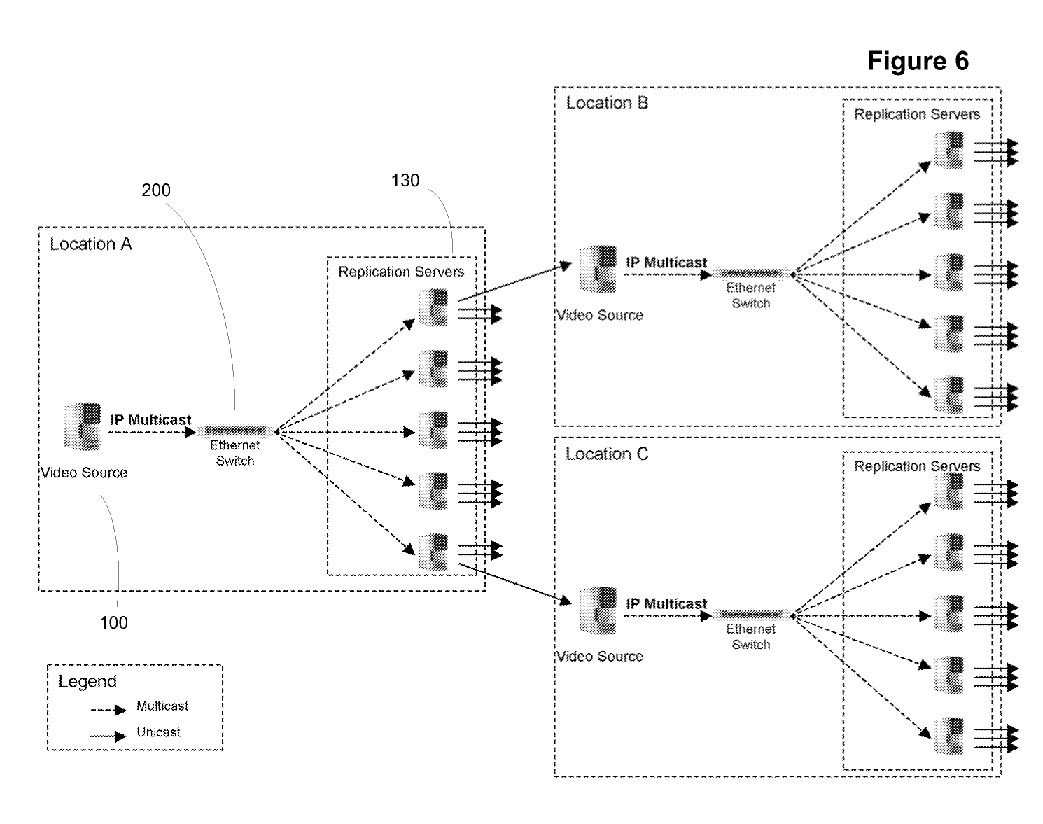

FIG. 6 shows an embodiment of the invention configured for replication groups serving a geographic area, disparate companies or disparate networks that serve mobile phones or Internet based computers for example. Since the same video source 100 drives all groups, the groups may be customized to show the video in location specific ways. For example, the video may be grouped to allow for the distribution in different geographic, or disparate corporate or alternate networks (mobile network versus Internet for example). In these cases, different watermarks or different processing may be utilized for error correction per network based on the type of network to control the quality of service provided by the system.

With respect to quality of service, various clock synchronization, forward error correction (FEC), automatic repeat request (ARQ) methods and systems may be utilized to provide higher quality of service for any embodiment of the invention:

These techniques may be utilized in any combination with the embodiments described herein and as described in U.S. patent Ser. No. 11/177,507 filed Jul. 7, 2005 which claims benefit of 60/521,821 filed Jul. 7, 2004 the specifications of which are hereby incorporated herein by reference. These patent applications enable minimal latency transport of real-time or live audio or video such as video conferencing or video streaming through time-synchronized error recovery and jitter removal for example and may be utilized in embodiments of the replication servers detailed herein.

These techniques may be utilized in any combination with the embodiments described herein and as described in U.S. patent Ser. No. 11/184,486 filed Jul. 19, 2005 which claims benefit of 60/521,904 filed Jul. 19, 2004 the specifications of which are hereby incorporated herein by reference. These patent applications enable synchronization of a local clock to a remote clock over a packet-switched network having significant packet jitter for example and may be utilized with the replication servers in embodiments of the invention that encounter links with significant packet jitter.

These techniques may be utilized in any combination with the embodiments described herein and as described in U.S. patent Ser. No. 11/184,485 filed Jul. 19, 2005 which claims benefit of 60/522,063 filed Aug. 9, 2004 the specifications of which are hereby incorporated herein by reference. These patent applications enable robust, low-latency transport over packet switched network to minimize and bound latency and jitter added by forward error correction (FEC) and may be utilized with the replication servers detailed herein.

These techniques may be utilized in any combination with the embodiments described herein and as described in U.S. patent Ser. No. 11/269,432 filed Nov. 8, 2005 which claims benefit of 60/626,243 filed Nov. 8, 2004 the specifications of which are hereby incorporated herein by reference. These patent applications enable aggregation of separate links to increase throughput and reliability for packetized transport and may be utilized with the replication servers detailed herein.

These techniques may be utilized in any combination with the embodiments described herein and as described in U.S. patent Ser. No. 11/282,238 filed Nov. 18, 2005 which claims benefit of 60/629,509 filed Nov. 18, 2004 the specifications of which are hereby incorporated herein by reference. These patent applications provide an alternative to TCP/IP protocol for reliable packet transmission by means of a modification of a selective repeat, continuous automatic repeat request (ARQ) error correction mechanism for packetized data, and may be utilized with the replication servers detailed herein as an alternative to the use of commercially available replication servers that utilize TCP/IP protocol.

It should be made clear that the techniques of this present invention may also be used independently of, and without the use of, any of the aforementioned embodiments or technologies described in these referenced United States Patent applications. In particular, the present invention may be used with commercially available replication servers, such as those currently sold by MICROSOFT® and REAL NETWORKS® that use TCP/IP protocol and other means of insuring reliable video stream transmission over IP networks.

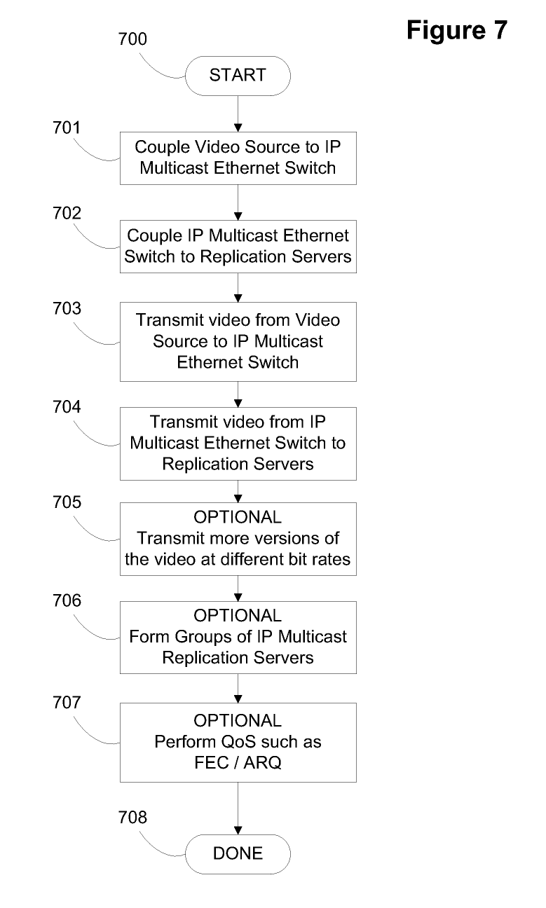

FIG. 7 shows a flow chart enabling an embodiment of the method. Processing begins at 700. A video source is coupled with a multicast Ethernet switch at 701. Any type of network device that is capable of multicasting IP packets may be utilized in step 701. The IP/Ethernet multicast Ethernet switch is coupled with replication servers at 702.

Although Ethernet multicast is utilized in this particular example to communicate with the replication servers, the replication servers may utilize any communication technique to communicate with devices that desire the video stream, including broadcasting as well as other types of physical layers and their particular Layer 2 multicasting or broadcasting protocols. For example, WiFi wireless network devices (IEEE802.11a/b/g/n) broadcast each packet to all the WiFi receiving devices that are tuned to the same channel. Although WiFi devices use a different Layer 2 protocol than Ethernet, they can also efficiently multicast video streams to multiple receiving devices. In another example, an embodiment can utilize Layer-3 switches that support IGMP multicasting over a coordinated region of Internet nodes all belonging to the same network carrier, to eliminate unnecessary replication servers.

Continuing with the description of FIG. 7, the video from the video source is transmitted to the IP multicast Ethernet switch at 703, and the video is transmitted to replication servers at 704. Optionally, the video may be reformatted to have a different bit rate at 705. This allows for smaller screens on some devices which may also have a smaller bandwidth network connection to view the video for example. Optionally, groups may be formed at 706 to allow for multiple geographic or company segmentations or customizations of the video.

Optionally, quality of service techniques may be employed at 707, for example to forward error correct or perform automatic repeat request for missing packets using connection based communications in the reverse direction compared with video flow. The types of quality of service techniques that may be utilized with embodiments of the method detailed herein include the patent applications incorporated by reference in the description of FIG. 6 above and may include other quality of service enhancements depending on the implementation.

While the invention herein disclosed has been described by means of specific embodiments and applications thereof, numerous modifications and variations could be made thereto by those skilled in the art without departing from the scope of the invention set forth in the claims.

What is claimed is:

1. A video over IP distribution system comprising:
a video source;
a multicast switch coupled with said video source;
a plurality of replication servers coupled with said multicast switch;
said video source configured to transmit a video to said multicast switch;
said multicast switch configured to transmit said video from said video source to said replication servers wherein said video comprises multicast video packets; and,
said replication servers configured to output said video as output video packets wherein said output video packets does not comprise multicast video packets.

2. The video over IP distribution system of claim 1 further comprising:
said video output in a plurality of bit rates.

3. The video over IP distribution system of claim 1 further comprising:
a plurality of groups of replication servers.

4. The video over IP distribution system of claim 1 further comprising:
said video output packets output with synchronized error recovery and jitter removal.

5. The video over IP distribution system of claim 1 further comprising:
said video output packets output with synchronized local clock and remote clock.

6. The video over IP distribution system of claim 1 further comprising:
said video output packets output with minimized and bound latency.

7. The video over IP distribution system of claim 1 further comprising:
said video output packets output with aggregated separate links.

8. The video over IP distribution system of claim 1 further comprising:
said video output packets output with automatic repeat request.

9. A method for video over IP distribution comprising:
coupling a video source to a multicast switch;
coupling said multicast switch to a plurality of replication servers;
transmitting a video from said video source to said multicast switch; transmitting said video from said multicast switch to said replication servers wherein said video comprises multicast video packets; and,
outputting said video from replication servers wherein said video does not comprise multicast video packets.

10. The method for video over IP distribution of claim 9 further comprising:
outputting said video in a plurality of bit rates.

11. The method for video over IP distribution of claim 9 further comprising:
forming said replication servers into groups.

12. The method for video over IP distribution of claim 9 further comprising:
outputting video output packets with synchronized error recovery and jitter removal.

13. The method for video over IP distribution of claim 9 further comprising:
outputting said video output packets with synchronized local clock and remote clock.

14. The method for video over IP distribution of claim 9 further comprising:
outputting said video output packets with minimized and bound latency.

15. The method for video over IP distribution of claim 9 further comprising:
outputting said video output packets with aggregated separate links.

16. The method for video over IP distribution of claim 9 further comprising:
outputting said video output packets with automatic repeat request.

17. The method for video over IP distribution of claim 9 further comprising:
outputting said video output packets with TCP/IP protocol.

18. A video over IP distribution system comprising:
means for coupling a video source to a multicast switch;
means for coupling said multicast switch to a plurality of replication servers;
means for transmitting a video from said video source to said multicast switch;
means for transmitting said video from said multicast switch to said replication servers wherein said video comprises multicast video packets; and,
means for outputting said video from replication servers wherein said video does not comprise multicast video packets.

19. The video over IP distribution system of claim 18 further comprising:
means for outputting said video in a plurality of bit rates.

20. The video over IP distribution system of claim 18 further comprising:
means for forming said replication servers into groups.

21. The video over IP distribution system of claim 18 further comprising:
means for outputting video output packets with synchronized error recovery and jitter removal.
